(19) United States
(12) Patent Application Publication
(10) Pub. No.: US 2022/0138707 A1
(43) Pub. Date: May 5, 2022

(54) METHODS, SYSTEMS, AND DEVICES FOR ON-CHAIN STABLE TRANSACTION IN DECENTRALIZED CRYPTOCURRENCIES

(71) Applicant: Tunnel International, Inc., Boston, MA (US)

(72) Inventor: Frank Makrides, Belmont, MA (US)

(21) Appl. No.: 17/575,144

(22) Filed: Jan. 13, 2022

Related U.S. Application Data
(63) Continuation of application No. PCT/US19/62907, filed on Nov. 25, 2019.

(51) Int. Cl. G06Q 20/06; G06Q 20/38

(52) U.S. Cl. CPC G06Q 20/0658; G06Q 2220/00; G06Q 20/3829

(57) ABSTRACT

Disclosed herein are methods, systems, and devices for solving the technological problem of stabilization of value for transactions during transfer using volatile digital assets. An on-chain scalable solution of value stabilization with privacy is disclosed in addition to a Confidential Multi-chain with Intermediate Stable Account chain structure used to implement the methods. A method to cryptographically conceal the account balances and transacted amounts and collateral while staying publicly verifiable is also disclosed. A method to verify that a payment transaction with collateral between two accounts through the intermediate Stable account is valid without knowing the balances, transacted amounts, nor collateral is disclosed. A method to determine and store a digital asset price in a ledger is disclosed. A method to claim a payment from another account, so that the second account cannot refuse to pay in case is disclosed. Additional methods, systems, and devices are also disclosed.

### PRIORITY CLAIM

This application claims priority as a bypass continuation to PCT Patent Application Serial No. PCT/US19/62907 entitled “METHODS, SYSTEMS, AND DEVICES FOR ON-CHAIN STABLE TRANSACTION IN DECENTRALIZED CRYPTOCURRENCIES”, filed Nov. 25, 2019, the disclosure of which is incorporated herein by reference in its entirety.

### TECHNICAL FIELD

The present disclosure generally relates to cryptocurrencies and payment systems. More specifically, the disclosure applies to stabilization of value for transactions during transfer using a volatile digital asset.

### BACKGROUND

There is a technological problem wherein existing digital assets and/or cryptocurrencies (e.g. Bitcoin) are too volatile to be widely adopted as a payment system and be accepted by major merchants. If a cryptocurrency is used to pay for goods and/or services, its exchange rate to United States Dollars (USDs) or other fiat currency may significantly change by the end of the day. As such, a merchant risks losing money during the transfer.

There is a class of cryptocurrencies, called stable coins, aimed to solve the volatility problem. There are three main types of stable coins. These include fiat-collaterized, crypto-collaterized, and non-collaterized (e.g. seigniorage shares). Fiat-collaterized assets are backed by a real asset. For example, the USD, that is controlled by a central entity, has a risk of insolvency of the entity. Crypto-collaterized stable coins are backed by another crypto asset, thus having a risk of a “black swan” event where the asset collateralizing the coin may decrease significantly in value. Non-collaterized assets do not have collateral and are dependent on people believing that it will maintain the expected value, thus if a belief is lost the asset has a risk of going into a death spiral.

There is no existing solution for this volatility problem that is scalable and with privacy. Having such a solution is paramount for wide adoption as a global decentralized payment system.

Another issue with stable coins is that these are separate digital assets that peg fiat currency. People may want to hold the cryptocurrency of their choice that is not pegged to fiat currency and at the same time merchants that get paid with this digital asset want to be sure that the assets they got paid are pegged to the fiat currency. There is no on-chain solution with value stabilization for this scenario. This is especially true for decentralized (e.g. distributed), open, and permissionless ledgers where public entities can see data for all accounts within the ledgers.

Accordingly, a need exists for new methods, systems, and devices for improving stabilization of value for transactions during transfer using volatile digital assets.

### SUMMARY

Disclosed herein are methods, systems, and devices for solving the technological problem of stabilization of value for transactions during transfer using volatile digital assets associated with cryptocurrencies and payment systems.

In one embodiment, a computer-based system and method of stabilizing the value, transferred using a volatile digital asset, relative to fiat currency, with or without privacy, includes (1) sending transacted amount with collateral, by the processor, by sender, using a volatile digital asset to the intermediate account belonging to the receiver; (2) calculating, by the processor, the exchange rate difference between time when transaction initially happened and time of the claim; (3) claiming the portion of the transacted amount with collateral, by the processor, by receiver, so that the value in fiat currency for the receiver stays the same; and (4) claiming the rest portion of the initial transfer with collateral, by the processor, by sender.

In another embodiment, a computer-based system and method of concealing an account balance and transacted amounts, and collateral with the ability for the network to verify a transaction between any two accounts in a case when transacted value is stabilized using intermediate account, includes (1) encrypting transacted amount with collateral, by a processor, by sender, using shared (between sender and receiver) key, and storing it in intermediate account block; (2) generating transaction blinding, by the processor, by sender, and encrypting it using shared (between sender and receiver) key, and storing it in intermediate account block; (3) decreasing sender's account balance by transacted amount with collateral, by the processor, by sender, encrypting sender's new account balance with sender's private key; (4) calculating sender's next block blinding, by the processor, by sender, and encrypting it with sender's private key; (5) calculating, by the processor, new sender's commitment which is sender's new balance representation on the elliptic curve, calculating intermediate account block's new commitment which is transacted amount (with collateral) representation on the elliptic curve; (6) calculating, by the processor, by sender, zero knowledge proofs that sender's new balance and intermediate account block's transferred amount are more or equal than zero, and are not too large in a way that their sum may cause numerical overflow; (7) calculating, by the processor, by receiver, the correct portion of the initial transfer during claiming phase based upon exchange rate movement and encrypting it using shared (between sender and receiver) key, and storing it in intermediate account block; (8) calculating, by the processor, by receiver, the new transaction blinding of the intermediate account block, encrypting it using shared key; (9) calculating, by the processor, by receiver, new commitment and zero-knowledge proof of the intermediate account block; (10) calculating, by the processor, by receiver, new receiver's account balance and encrypting it with the private key, new block blinding and encrypting it with the private key, new commitment and zero-knowledge proof; (11) calculating, by the processor, by sender, the rest of the portion of the initial transfer during claiming phase based upon exchange rate movement and encrypting it using shared (between sender and receiver) key, and storing it in intermediate account block; (12) calculating, by the processor, by sender, the new transaction blinding of the intermediate account block, encrypting it using shared key; (13) calculating, by the processor, by sender, new commitment and zero-knowledge proof of the intermediate account block; and (14) calculating, by the processor, by sender, new sender's account balance and encrypting it with the private key, new block blinding and encrypting it with the private key, new commitment and zero-knowledge proof.

A computer-based system and method of validating, by all network participants, a payment transaction between accounts through the intermediate account whose balances were concealed using the method from the previous embodiment in a case when transacted value is stabilized using intermediate account, including (1) getting sender's and intermediate account's initial transfer (with collateral) data from the network including commitments, zero knowledge proofs, encrypted balances, encrypted blinding values, encrypted transacted amount with collateral; (2) verifying zero knowledge proofs that sender's new balance and intermediate account's initial transfer value are more or equal than zero, and are not too large in a way that their sum may cause numerical overflow; (3) verifying the sender's and intermediate account's commitment points on the elliptic curve to make sure no new assets were created in the system; (4) getting exchange rate movement data during time of the initial transfer and time of claiming the funds by the receiver; (5) getting transaction data of the receiver to claim the portion of the initial transfer from the network including commitments, zero knowledge proofs, encrypted balances, encrypted blinding values, encrypted portion of the initial transfer; (6) verifying zero knowledge proofs that receiver's new balance and intermediate account's portion of the initial transfer are more or equal than zero, and are not too large in a way that their sum may cause numerical overflow; (7) verifying the receiver's and intermediate account's commitment points on the elliptic curve to make sure no new assets were created in the system; (8) verifying the correct portion of the initial transfer was claimed by receiver using the intermediate account's commitment points and exchange rate movement; (9) getting transaction data of the sender to claim the rest portion of the initial transfer from the network including commitments, zero knowledge proofs, encrypted balances, encrypted blinding values, encrypted rest portion of the initial transfer; (10) verifying zero knowledge proofs that sender's new balance and intermediate account's rest portion of the initial transfer are more or equal than zero, and are not too large in a way that their sum may cause numerical overflow; (11) verifying the sender's and intermediate account's commitment points on the elliptic curve to make sure no new assets were created in the system; and (12) verifying the correct portion of the initial transfer was claimed by sender using the intermediate account's commitment points and exchange rate movement.

In another embodiment, a Confidential Multi-chain with Intermediate Stable Account chain computer-based memory structure in use together with computer-based methods to conceal the balance and transacted amounts, includes a memory and a set of chains stored in the memory, where each chain represents an individual account and tracks either balance changes with privacy (regular accounts) or transacted amounts with privacy (Stable accounts); and computer-based methods to conceal the balance and transacted amounts.

In another embodiment, a multi-chain without privacy with Intermediate Stable Account chain computer-based memory structure in use together with computer-based methods to send payment transactions, includes (1) a memory, (2) a set of chains stored in the memory, where each chain represents an individual account and tracks either balance changes (regular accounts) or transacted amounts (Stable accounts); and (3) computer-based methods to send payment transactions;

In another embodiment, a computer-based system and method to determine and store a digital asset price in a ledger, includes a set of incentivized special network nodes. The computer-based system implements a method including (1) accessing a set of predefined exchanges by a network node to get the digital asset quotes and calculating a price using a predefined formula; (2) sending a vote, by the processor, by each special network node, with the asset price to other network nodes; (3) reaching consensus on the asset price by the majority of votes; and (4) storing, by the processor, the asset price in an immutable ledger structure.

In another embodiment, a computer-based system and method to claim a payment from another account so that the second account cannot refuse to pay in case, for example, if there is no node running that account or it is unavailable. The computer-based system includes a set of incentivized special network nodes. The method includes (1) exposing, by the processor, by account owner, the account's private key so that other accounts can sign a transaction; (2) accessing, by the processor, by receiver, the head block of the account with exposed private key; (3) generating the blocks and signing the transaction, by the processor, by receiver, from the account with exposed private key; (4) validating, by each special network node, that the account is eligible to withdraw funds and sending a vote to approve or disapprove the transaction; and (5) reaching consensus on the transaction validity by the majority of votes.

In another embodiment, a computer-based system executing offline transactions in a Confidential Multi-Chain, includes a memory; a set of chains stored in the memory, where each chain represents an individual account and tracks either balance changes with privacy (regular accounts) or transacted amounts with privacy (Offline accounts); computer-based methods to conceal the balance; and a set of incentivized special network nodes implementing a method. The method includes (1) registering, by the processor, by receiver, an offline account and exposing its private key; (2) generating, by the processor, by sender, new blocks for the sender and offline accounts and sending the transaction to the network; (3) claiming, by the processor, by receiver, the transacted amount from the offline account by creating new blocks for the receiver and offline accounts and sending the transaction to the network; (4) validating, by each special network node, that the receiver is eligible to withdraw funds and sending a vote to approve or disapprove the transaction; and (5) reaching consensus on the transaction validity by the majority of votes. The method may further include executing offline transactions in a multi-chain without privacy.

In another embodiment, a computer-based system and method to execute transactions using smart contract in a Confidential Multi-Chain, includes (1) a memory; (2) a set of chains stored in the memory, where each chain represents an individual account and tracks either balance changes with privacy (regular accounts) or transacted amounts with privacy (Offline and/or Stable accounts) and blocks, containing conditions and/or rules and/or code to execute, stored in the memory; and (3) a set of incentivized special network nodes. The method includes (1) generating, by the processor, by sender and/or receiver, a block with condition and/or rule and/or code (smart contract) and signing it by both sender and receiver; (2) checking conditions and/or rules and/or code of the contract by each or some of the special incentivized nodes and executing transfers between accounts based on them; (3) validating, by each special network node, that the receiver is eligible to withdraw funds and sending a vote to approve or disapprove the transaction; and (4) reaching consensus on the transaction validity by the majority of votes. In some embodiments, the method may further include (5) executing transactions using smart contract in a multi-chain but without privacy.

In another embodiment, a computer-based system and method to validate that an account has at least s amount of coins without knowing the exact amount, includes a memory and a set of network nodes. The method includes (1) generating, by the processor, commitment for the account balance, and storing in the memory; (2) generating, by the processor, zero-knowledge proof that the account has at least s coins, and storing in the memory; and (4) validating, by the network nodes, that the account has at least s coins without knowing the exact balance.

In another embodiment, a system, includes a memory, a network interface; an I/O interface; and a processor, communicating with the memory, network and I/O interface, where it is configured to perform a method. The method includes (1) accessing the memory where sender's or receiver's balance chain or intermediate account's chain is stored; (2) generating a transaction when sender submits a command using I/O interface to initiate a payment with collateral or receiver sends a command using I/O interface to claim a portion of the initial transfer or sender sends a command using I/O interface to claim the rest portion of the initial transfer; (3) exchanging data between network nodes using a network interface; and (4) validating the transactions by all network participants using the method described in the third embodiment.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 depicts a diagram illustrating a Confidential Multi-Chain structure wherein each chain represents an individual account and tracks balance changes with privacy in accordance with embodiments of the present disclosure.

FIG. 2 depicts a diagram illustrating a special Stable account type wherein the Stable account is linked to a Merchant account and the Stable account tracks transacted amounts with privacy in accordance with embodiments of the present disclosure.

FIG. 3 depicts a diagram illustrating a method to determine and store a digital asset price in a decentralized network in accordance with embodiments of the present disclosure.

FIG. 4 depicts a diagram illustrating a system and method allowing an account to claim a payment from another special account such that the second account cannot refuse to complete the payment (e.g. if there is not a node running the account or the account is unavailable) in accordance with embodiments of the present disclosure.

FIG. 5 depicts a diagram illustrating formulas (i.e. equations) and transaction elements when a customer sends payment to the merchant through the Stable account in accordance with embodiments of the present disclosure.

FIG. 6 depicts a diagram illustrating details of a transaction flow in accordance with embodiments of the present disclosure.

FIG. 7 depicts a diagram illustrating a method and a data structure to support offline transactions in a Confidential Multi-Chain in accordance with embodiments of the present disclosure.

FIG. 8 depicts a diagram illustrating a method for a smart contract to execute transactions in a Confidential Multi-Chain in accordance with embodiments of the present disclosure.

FIG. 9 depicts a diagram illustrating a method to validate that an account has at least s amount of coins without knowing the exact amount in accordance with embodiments of the present disclosure.

FIG. 10 depicts a block diagram illustrating an example of a computing device and/or a computing system configured to conceal the balance and transacted amount, process and validate a payment transaction through a Stable account in accordance with embodiments of the present disclosure.

### DETAILED DESCRIPTION

The present disclosure relates to cryptocurrencies and payment systems. More specifically; methods, systems, and devices are disclosed for solving the technological problem of stabilization of value for transactions during transfer using volatile digital assets.

The following description and figures are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The disclosed methods, systems, and devices solve the technological problem of digital asset volatility when a customer sends a payment to a merchant using volatile cryptocurrency and the value of the transacted amount should be stable relative to fiat currency, preserving the privacy of the balance and transacted amount and with the ability for the network to verify a transaction between any two accounts in a ledger.

Details of the data structure and transaction flow are disclosed herein, however, it is to be understood that these are merely examples and specific structural and functional details should not be interpreted as limiting but rather should help to understand the concept and serve as the basis of the claims.

It is to be understood that the methods described below can work and be used without privacy by not encrypting the balances and transacted amounts and making some of privacy fields optional like commitments and zero-knowledge proofs, so having the privacy feature should not be interpreted as limiting, but rather as an additional important feature.

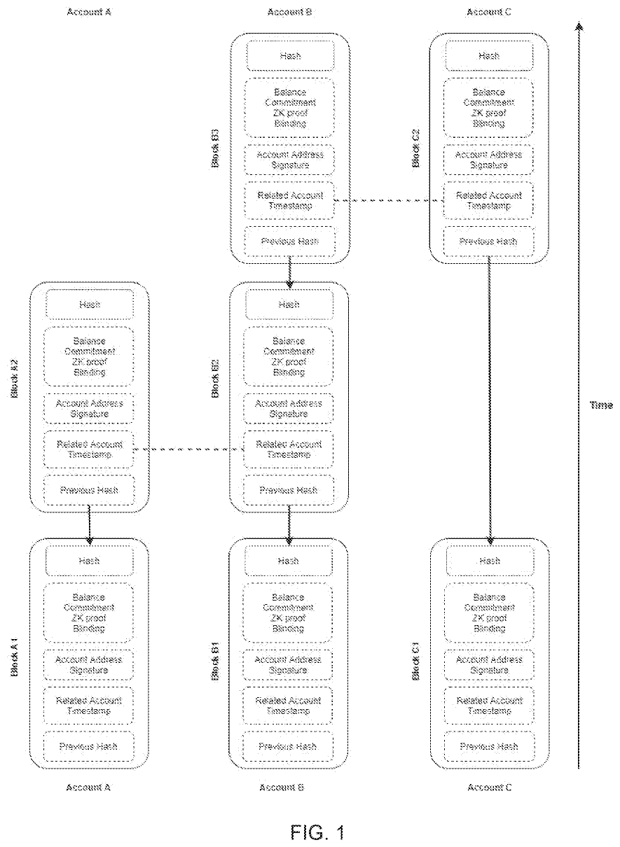

FIG. 1 shows a Confidential Multi-chain structure, which is one example of multi-chain ledger structure where each chain represents an individual account and tracks balance changes, but with privacy. It shows three accounts each having an individual chain of blocks. The chain has a sequence of blocks that are linked by means of cryptographic hash function like SHA-2: Previous Hash field of the next block contains the Hash of the previous block. Hash is not required to be stored, it can be calculated dynamically based on the content of the block. Each new block contains the updated total account balance, so the chain can be viewed as the history of balances (and maybe other state fields) where the top block has the actual account balance. Each block has a digital signature made by the account holder using a pair of the holder's private and public keys. Each block has the Account Address which can be the encoded public key. When a transaction between 2 accounts happens, the corresponding 2 chains are linked together, for example by a pair of Related Account and Timestamp fields; this link does not necessarily have a direction but at a minimum means that transaction happened. A lot of variations of the multi-chain block fields are possible, including, but not limited to: the block may have Height and Related Height fields where Height is the block number in the sequence of blocks and Related Height may be used to refer to the block number in the other chain with which transaction happened, or when two blocks are linked with a random number which is the same number in two blocks so that they can be matched, or Timestamp can be an optional field, etc. The block contains a set of fields for privacy, including, but not limited to: Balance, Blinding, Commitment, Zero-knowledge proof Balance contains total account balance. Blinding is a number usually generated as a random number or based on multiple random numbers that help building Commitment and/or Zero-knowledge proof. Commitment is a cryptographic primitive that allows one to commit to a chosen value while keeping it hidden to others; examples of commitments are Pedersen Commitment, zk-SNARK commitment, zk-STARK commitment, etc. Zero-knowledge proof is a cryptographic primitive that proves to another party the knowledge of some value without conveying any information apart from the fact that they know the value; examples of zero-knowledge proof protocols are Range Proof, Bulletproof, zk-SNARK, zk-STARK, etc. In one of possible variations of the block structure, the Balance and Blinding fields can be kept only for the head block as these two fields are not part of validation of the previous transactions but are rather needed to construct new block. As shown, Account A had block A₁, Account B had block B₁, then transaction happened which resulted in construction of new blocks A₂ and B₂ and the link to denote the transaction. The picture also shows the next transaction between Account B and Account C which resulted in construction of blocks B₃ and C₂ and the link between them. It is to be understood that these details should not be interpreted as limiting and the various forms of multi-chain structures or DAG structures with different fields may exist. The key concept is that the block stores the total account balance and each account (or group of accounts) has a separate chain. This data structure enables high scalability when transactions between accounts may happen in parallel.

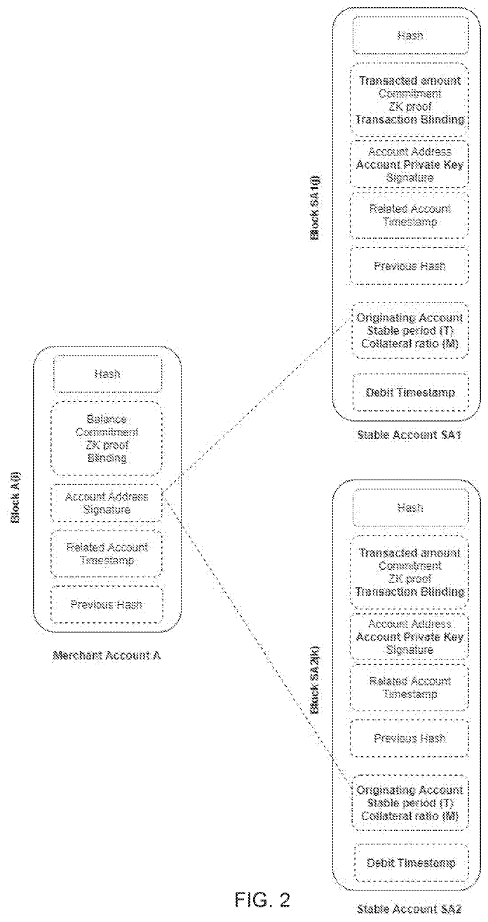

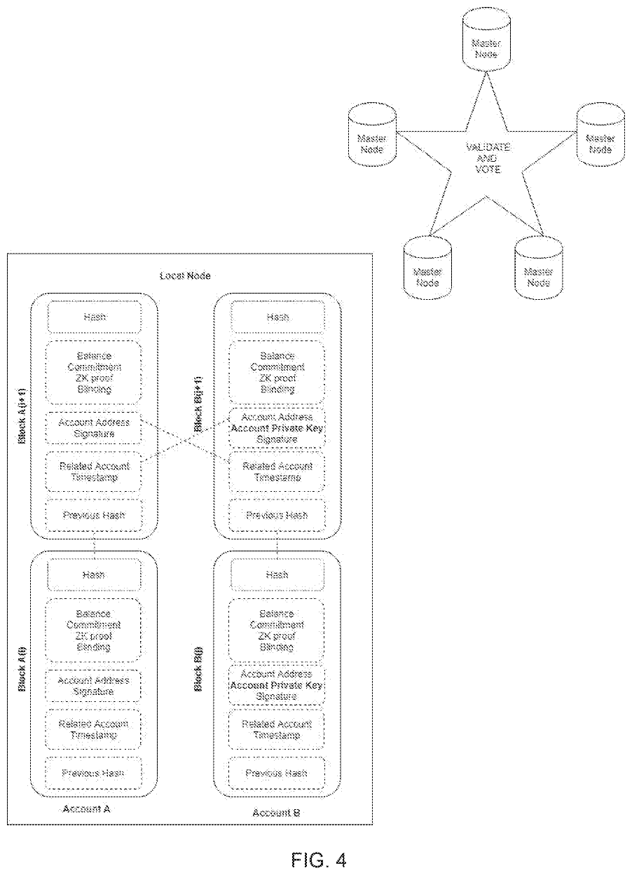

FIG. 2 introduces a special Stable account type where the Stable account is linked to a Merchant account and tracks transacted amounts with privacy. Unlike the regular accounts described in FIG. 1 which track balances, the Stable account tracks transacted amounts (Transacted amount field). The other big difference from the regular account is that Stable account exposes both public and private keys (Account Private Key field) to all network participants—this is needed for the buyer and seller to claim their digital assets from the Stable account independently without relying on each other. If the Merchant is insolvent or node is not available, the sender can still sign the transaction with the Stable account private key (see FIG. 4 for more details). Exposing the private key does not possess a risk of stealing the money as all transactions are anyway validated by a set of master nodes that participate in voting and operate by certain rules and have incentive/penalty to obey the rules. Merchant will create and register one or many Stable accounts to ensure enough level of concurrency. Originating Account field is a new field that points to the Merchant address/public key—the payment can be claimed only by the originating account which is the merchant address. At the time the Stable account is created, the Merchant needs to specify two fields: Stable period (T) and Collateral ratio (M). The transacted amount is stabilized for a certain period of time Stable period (T)—enough for the merchant to batch the transactions and exchange the digital assets to fiat currency as one large exchange transaction. It could be one day, one week, or any other duration up to some maximum (for example, the system may limit that duration cannot be more than 30 days). Stabilization requires collateral from the sender with certain Collateral ratio (M) set by Merchant which can be minimum of 1 (means no collateral) and up to some maximum (for example, the system may limit that ratio cannot be more than 5). The Collateral ratio of 2 means that the buyer will need to send 2× amount to the Stable account where X is the price of goods being purchased. The merchant can claim the payment from the Stable account any time during the Stable period at the current exchange rate (fiat to cryptocurrency rate) or after Stable period at the exchange rate as of the end of the Stable period. The buyer can claim the rest of his funds from the Stable account as soon as the Merchant claims his payment or right after the Stable period at the exchange rate as of the end of the Stable period. Originating Account, Stable period (T) and Collateral ratio (M) cannot be changed (or optionally can be changed) for the Stable account. The two examples below explain how it works:

Example 1: January 1^{st} —1 coin costs 3 USD. Buyer purchases goods worth of 6 USD or 2 coins. He pays 4 coins (Collateral ratio M=2) and the Stable period T=2 days. January 2^{nd}—coin exchange rate drops 33% and 1 coin costs 2 USD. Merchant claims payment on January 2^{nd} at current exchange rate which is 6 USD or 3 coins. The buyer claims the rest of the funds which is 1 coin.

Example 2: January 1^{st} —1 coin costs 3 USD. Buyer purchases goods worth of 6 USD or 2 coins. He pays 4 coins (Collateral ratio M=2) and the Stable period T=2 days. January 2^{nd}—coin exchange rate increases 100% and 1 coin costs 6 USD. Merchant claims payment on January 2^{nd} at current exchange rate which is 6 USD or 1 coin. The buyer claims the rest of the funds which is 3 coins.

These examples demonstrate that the Merchant receives the same amount relative to fiat currency and the buyer keeps volatile asset that can increase or decrease in value.

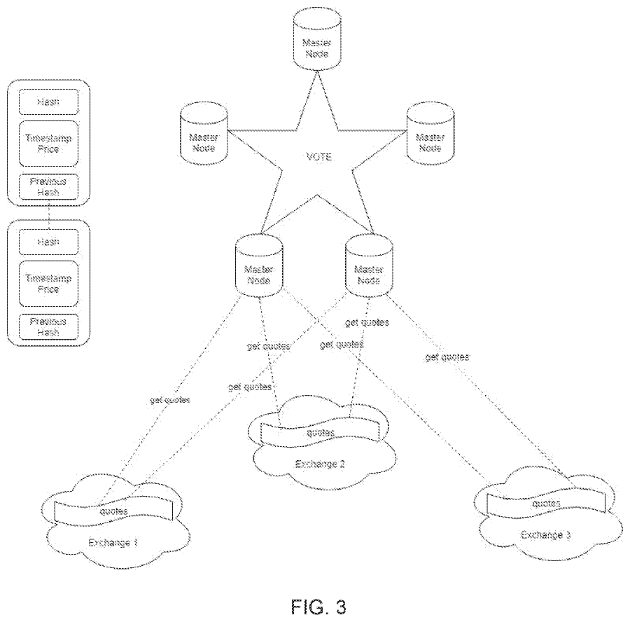

Debit Timestamp field is used to refer to the block where the buyer sent the payment with collateral from the block where the Merchant claims the payment and from the block where the buyer claims the rest of the funds. Based on Debit Timestamp and current timestamp and exchange rates (see more details in FIG. 3), the buyer and the Merchant can calculate the final settlement amount.

Transaction Blinding (TBLD_{i,j}) is a random number known only to the pair of sender and receiver participating in a transaction, it helps to conceal the balance and amounts transferred.

FIG. 3 shows the method to determine and store a digital asset price in decentralized network. As all network participants need to be able to validate a transaction, they all need to agree on the exchange rate of the digital assets to the fiat currency. Each of the Master Nodes (a node that holds a significant amount of digital assets, performs a special function and incentivized to work as an honest node) will periodically get the exchange rates from a pre-determined set of exchanges (for example, cryptocurrency exchanges) and exchange the votes with each other on what the rate should be for each specific time. Majority of the Master Nodes need to run the same version of the software to come to a consensus on the rate. The equation of the rate may depend on the price and volume from each exchange. The majority of votes determine the consensus rate. The exchange rate is stored in an immutable ledger where each block may have Hash, Previous Hash, Price, Timestamp, and other fields.

FIG. 4 shows a system and method how an account can claim a payment from another special account so that the second account cannot refuse to pay, for example if there is no node running that account or it is unavailable. This relates to special accounts, like Reward accounts or Stable accounts.

In the case with Reward accounts, an account wants to claim a certain amount of digital assets for the work done in the network (like validating transactions or packet routing) from the Reward account. If a designated entity is holding the funds of the Reward account and running the node, the system would need to trust that entity that it won't use the funds for its own needs and that it keeps running the node which makes the system trusted and centralized.

In the case with Stable accounts, the sender is sending the payment with collateral and expects to receive the collateral back at some future date. If the merchant or other entity is holding the collateral and running the node, then this makes the system trusted and centralized, as if the merchant becomes insolvent or the node stops running, the sender may not get the collateral back.

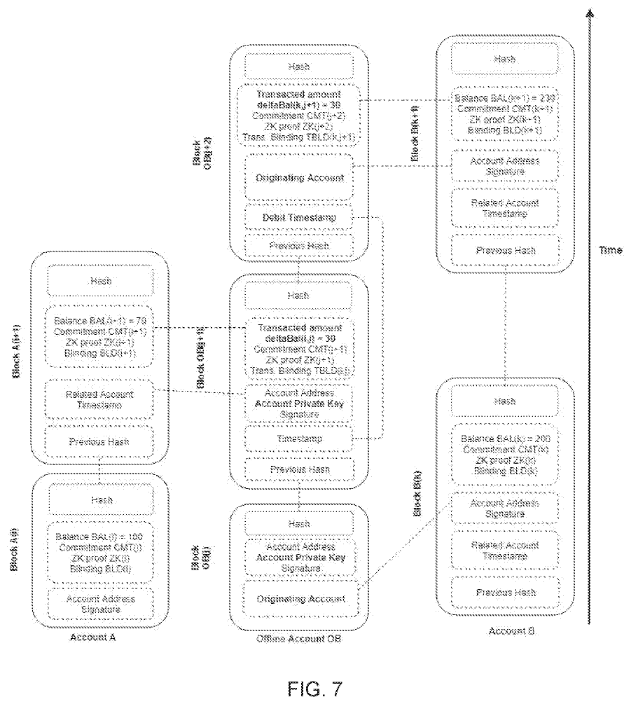

The Smart Contracts approach, used in Ethereum or other networks, may not work in the architecture where both sender and receiver need to be online for transaction to happen. Note, in FIG. 7 I will show how offline transactions will be supported for the presented architecture, thus allowing the option of using a smart contract for the offline accounts.

The solution for the problem is that the special account, like Reward account or Stable account, needs to expose the private key for all network participants. In this case, the account node can download the head block of the special account, generate a new block and sign the payment transaction from that special account using the published private key. So there is no need for a central entity to hold the funds or run the node. Instead, anyone can run that account on its own node and send a payment to his account. Exposing the private key does not possess a risk of stealing the money as all transactions are anyway validated by a set of Master Nodes that participate in voting and operate by certain rules and have incentive/penalty to obey the rules. So, if the account is not eligible for the reward then Master Nodes will not vote for the transaction. If the sender is trying to claim more coins than the collateral sent, then Master Nodes will not vote for the transaction. FIG. 4 shows how Account B exposed its Private Key in the block, Account A running on the local node downloaded the chain for Account B, generated the block and signed the transaction to transfer funds from Account B to Account A, and a set of Master Nodes voted to approve or disapprove the transaction.

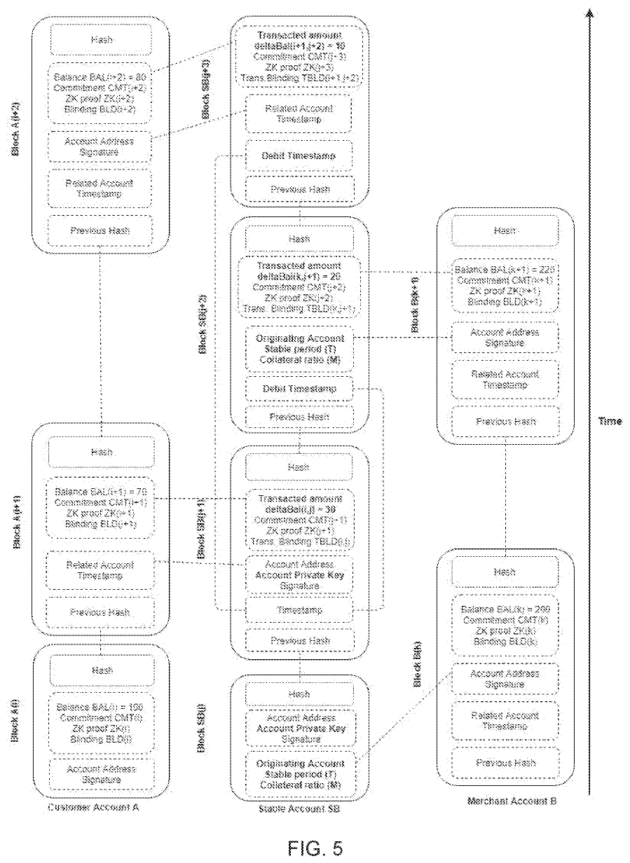

FIG. 5 demonstrates the following scenario as an example to understand the concept of transaction stabilization: Customer Account A has a balance of 100 coins (see Block Aᵢ, where i is the index of the block in Customer Account A). Merchant Account B has a balance of 200 coins (see Block Bₖ, where k is index of the block in Merchant Account B). The Merchant sets collateral ratio M to 2 and stable period T to 2 days. Price of 1 coin is 2 USD. The Customer is buying goods from the Merchant worth of 15 coins or 30 USD. As the collateral ratio is 2, the Customer transfers 30 coins to the Stable account (see Block SBⱼ₊₁, where j is the index of the block in Stable Account SB) and has 70 coins left in his wallet (see Block Aᵢ₊₁). The next day the exchange rate dropped 25% so that 1 coin is now 1.5 USD. The Merchant claims the funds that day as he is ready to sell the funds on exchange. The Merchant is eligible to claim 20 coins or 30 USD (see Block SBⱼ₊₂), since he is expecting to receive the same value in USD as of the day of purchase, and his balance is now 220 coins (see Block Bₖ₊ᵢ). The Customer can claim 10 coins left (see Block SBⱼ₊₃) and his balance is now 80 coins (see Block Aᵢ₊₂). All the balances and transacted amounts are encrypted and unknown to network participants however anyone can verify that the transactions were valid and no new money were created (meaning that BALᵢ+BALₖ=BALᵢ₊₂+BALₖ₊₁) and that the Customer and Merchant claimed the correct portion of the initial transfer, as I will show below.

Details of the data structure and transaction flow are disclosed herein, however, it is to be understood that these are merely examples and specific structural and functional details should not be interpreted as limiting but rather should help to understand the concept and serve as the basis of the claims.

It is to be understood that the described method can work and be used without privacy by not encrypting the balances and transacted amounts and making some of privacy fields optional like commitments and zero-knowledge proofs, so having the privacy feature should not be interpreted as limiting, but rather as an additional important feature.

FIG. 5 shows key elements of the method with abbreviations: balance, commitment, zero-knowledge proof, block blinding, transacted amount, and transaction blinding. I will focus on one commitment schema—Pedersen Commitment for the purpose of explaining the balance concealing method and use of Confidential Multi-chain structure, however it is to be understood that other commitment schemas and various zero knowledge proof protocols can be used with Confidential Multi-chain structure.

Balance field (BALᵢ) contains total account balance, which is stored cryptographically encrypted, at the time of Blockᵢ—only the owner of account who possesses the private key can decrypt the value. AES or any other encryption method can be used to encrypt the field. Balance is always encrypted when transferred thorough the network. Note, the Stable account exposes the private key, thus it cannot store the balance field because it would be known to everybody; instead, the Stable account stores Transacted amount which is encrypted using the shared key of the sender and receiver.

Blinding field (BLDᵢ) is a random number that can be generated like a private key for the elliptic curve. Each block has a unique blinding that is stored encrypted and only known to the account holder. Initially, the first block of the account with zero balance may have blinding equal to zero: BLD₀=0. Blinding is always encrypted when transferred thorough the network.

Transaction Blinding (TBLD_{i,j}) is a random number known only to the pair of sender and receiver participating in a transaction. For the transaction through the Stable account, the Transaction Blinding is persisted in the Stable account block (note that the merchant's, not the stable account's, keys are used, otherwise everyone would be able to know the shared key and decrypt the transaction blinding). It is encrypted by sender (for example, Customer Account A) and decrypted by receiver (for example, Merchant Account B) or vice versa, using the shared secret known as Elliptic-curve Diffie-Hellman secret as shown in Equations [1] and [2].

Secret EC Point_{i,j}=Priv_{A}*Pub_{B}=Priv_{B}*Pub_{A} [1]

Shared Key_{i,j}=X coordinate of Secret EC Point_{i,j} [2]

Priv_{A} and Pub_{A} is a pair of private and public keys for Customer Account A, and Priv_{B} and Pub_{B} is a pair of private and public keys for Merchant Account B. Note that Transaction Blinding in a single block is not known to other network participants.

Blinding of the next block is calculated using the Blinding of the previous block and by adding or subtracting the Transaction Blinding as shown in Equations [3] and [4].

Sender BLDᵢ₊₁=BLDᵢ−TBLD_{i,j} [3]

Receiver BLDₖ₊₁=BLDₖ+TBLD_{k,j} [4]

Transacted amount (deltaBAL_{i,j}) is the amount of coins or digital assets transferred from sender to the receiver as part of the transaction which includes collateral. For the transaction through the Stable account, the Transacted amount is persisted in the Stable account block (note that the merchant's, not the stable account's, keys are used, otherwise everyone would be able to know the shared key and decrypt the Transacted amount). It is encrypted by sender (for example, Customer Account A) and decrypted by receiver (for example, Merchant Account B) using the shared secret known as Elliptic-curve Diffie-Hellman secret Shared Key_{i,j}. The new balances after the transaction should satisfy Equations [5] and [6].

Sender BALᵢ₊₁=BALᵢ−deltaBAL_{i,j} [5]

Receiver BALₖ₊₁=BALₖ+deltaBAL_{k,j} [6]

Commitment field (CMTᵢ) is a Pedersen Commitment where the value calculated as shown in Equation [7].

CMTᵢ=BLDᵢ*H+BALᵢ*G [7]

G is the original generator point and H is an additional generator point on the Elliptic Curve such that no one knows the discrete logarithm for H with respect to G. Note, in a variation of the method G and H can be generation points for two different Elliptic Curves.

Commitment field (CMTⱼ) for the block of the Stable account is calculated as shown in Equation [8].

CMTⱼ₊₁=TBLD_{i,j}*H+deltaBAL_{i,j}*G [8]

Since balances are encrypted with the private key known to the account owner only, and transacted amounts are encrypted with the shared key known only to the sender and receiver, the network participants do not know account balances and transacted amounts. It will be shown in Equations [9] and [10] how network participants can use Pedersen commitments to validate that equation [5] is true and no new money is created as part of sending the payment with collateral to the Stable account.

CMTᵢ₊₁=BLDᵢ₊₁*H+BALᵢ₊₁*G=(BLDᵢ−TBLD_{i,j})*H+(BALᵢ−deltaBAL_{i,j})*G=BLDᵢ*H+BALᵢ*G−TBLD_{i,j}*H−deltaBAL_{i,j}*G=CMTᵢ−TBLD_{i,j}*H−deltaBAL_{i,j}*G=CMTᵢ−CMTᵢ₊₁ [9]

CMTᵢ=+CMTᵢ₊₁+CMTⱼ₊₁ [10]

Validating that the old balance before the transaction equals to the sum of the new balance and the transacted amount after the transaction, as shown in Equation [5], is equivalent to validating that the commitment Elliptic Curve point representing the old balance before the transaction equals to the sum of commitment points representing the new balance and transacted amount after the transaction, as shown in Equation [10], provided that H is selected so that no one knows the discrete logarithm for H with respect to G and that the balance is not a negative number and does not overflow when any two balances are added. The advantage of using commitments is that by knowing the commitment it is computationally unfeasible to derive the balance or transacted amount.

Zero-knowledge proof (ZKᵢ) contains a prove that value BALᵢ is in the range of [0, N], where N is a large number (for example, 2⁶⁴) without revealing the value. Without zero-knowledge proof an attacker could send more coins than he has leaving his total balance negative in one wallet and creating new coins in the second wallet while commitments would still add up. One of the popular zero-knowledge proof protocols that can used is called Bulletproof which is calculated and verified based on BALᵢ, BLDᵢ and CMTᵢ. For the Stable account, zero-knowledge proof is calculated and verified based on TBLD_{i,j}, deltaBAL_{i,j} and CMTⱼ₊₁. All the committed values in the Stable account must be non-negative numbers and zero-knowledge proof will be used by the network to verify that.

When the Merchant wants to claim the coins from the Stable account (during period T), deltaBAL_{k,j+1} needs to be calculated which is the Merchant's part of the initial transfer deltaBAL_{i,j}.

Let Rₜ₀^{USD} be the price of coin in USD (or other fiat currency) at the moment when Customer paid for the goods. In this example Rₜ₀^{USD} is 2 USD per coin.

Let Rₜ^{USD} be the price of coin in USD at the moment of claiming the coins by the Merchant (or at the moment of t₀+T, if was not claimed during period T). In this example Rₜ^{USD} is 1.5 USD per coin. Note, that if the Merchant has not claimed the funds during period T, then the Customer can claim his portion of the initial transfer before or after the Merchant claims his portion as the price of coin in USD will be known at the moment of t₀+T and the Customer is able to calculate his portion (this is to ensure that if the Merchant never claims, the Customer still gets his portion).

Let Pₜ₀^{USD} be the price of purchased goods by the Customer in USD (or other fiat currency) at the moment when Customer paid for the goods. In this example Pₜ₀^{USD} is 30 USD.

Let Pₜ^{USD} be the price of purchased goods in USD (or other fiat currency) at the moment of claiming the coins by the Merchant (or at the moment of t₀+T, if was not claimed during period T).

The transaction to be stable requires that the price is USD for the Merchant does not change as shown in Equation [11]

Pₜ₀^{USD}=Pₜ^{USD}

As described above, Equations [12], [13], and [14] are true.

$$\begin{matrix}{P}_{t 0}^{U S D} = \frac{{deltaBAL}_{i , j}}{M} * {R}_{t 0}^{U S D} & [ 12 ] \\ {P}_{t}^{U S D} = d e l t a B A {L}_{k , j + 1} * {R}_{t}^{U S D} & [ 13 ] \\ \frac{{deltaBAL}_{i , j}}{M} * {R}_{t 0}^{U S D} = d e l t a B A {L}_{k , j + 1} * {R}_{t}^{U S D} & [ 14 ]\end{matrix}$$

Assume that Rₜ^{USD}≠0 (if Rₜ^{USD}=0 then the Merchant can claim all deltaBAL_{i,j} coins).

Assume that Rₜ₀^{USD}≠0 (if Rₜ₀^{USD}=0 then the initial transaction will get denied). See Equations [15], [16], and [17].

$$\begin{matrix}d e l t a B A {L}_{k , j + 1} = \frac{{R}_{t 0}^{U S D}}{{R}_{t}^{U S D} * M} * d e l t a B A {L}_{i , j} & [ 15 ] \\ Let {d}_{0} = \frac{{R}_{t 0}^{U S D}}{{R}_{t}^{U S D} * M} & [ 16 ] \\ {deltaBAL}_{k , j + 1} = {d}_{0} * d e l t a B A {L}_{i , j} & [ 17 ]\end{matrix}$$

The Merchant is eligible to get d₀*deltaBAL_{i,j} but since he cannot get more than the payment with collateral, then see Equations [18] and [19].

Let d₁=Max(0,Min(1,d₀)) [18]

deltaBAL_{k,j+1}=d₁*deltaBAL_{i,j} [19]

Let c be the precision or the number of digits after the decimal point of d₁ (for example, c=5), then see Equation [20].

Let d₂=round_{c}(d₁) [20]

In Equation [20], d₂ is the rounded value of d₁ with precision c (for example, if c=5, then d₂=0.12345).

Note, as the result of rounding, if the rate increases too much (˜10^{c+1} times) and/or the payment was a very small number then the Merchant might claim 0 coins. See Equations [21] and [22].

$$\begin{matrix}d e l t a B A {L}_{k , j + 1} = {d}_{2} * d e l t a B A {L}_{i , j} & [ 21 ] \\ {deltaBAL}_{k , j + 1} = {d}_{2} * 1 {0}^{c} * \frac{{deltaBAL}_{i , j}}{1 {0}^{c}} & [ 22 ] \\ Let {d}_{3} = {d}_{2} * 1 {0}^{c} & [ 23 ]\end{matrix}$$

In Equation [23], d₃ is now a non-negative integer, next see Equation [24].

$$d e l t a B A {L}_{k , j + 1} = {d}_{3} * \frac{{deltaBAL}_{i , j}}{1 {0}^{c}} \qquad [ 24 ]$$

Since operations are used on the elliptic curve, as will be shown below, it is required that deltaBAL_{k,j+1} and deltaBAL_{i,j} are non-negative integers. Equation [24] is true only if deltaBAL_{i,j} is a non-negative integer with c zeros in the end, so that

$$\frac{{deltaBAL}_{i , j}}{1 {0}^{c}}$$

gives a non-negative integer. When the original transaction happens, the system should validate that the amount transferred deltaBAL_{i,j} has c zeros in the end. This is normally is not a big restriction, as the digital asset usually has a lot of decimal places and it is stored as an integer so the value 2.345700000 will be stored as 2345700000 and it will pass validation of 5 zeros in the end. See Equation [25].

10^{c}*deltaBAL_{k,j+1}=d₃*deltaBAL_{i,j} [25]

In Equation [25]; d₃, 10^{c}, deltaBAL_{k,j+1}, and deltaBAL_{i,j} are all non-negative integers.

Using Equation [8], see Equations [26], [27], [28], and [29].

$$\begin{matrix} ( {d}_{3} * C M {T}_{j + 1} ) = ( {d}_{3} * T B L {D}_{i , j} ) * H + ( {d}_{3} * d e l t a B A {L}_{i , j} ) * G & [ 26 ] \\ C M {T}_{j + 2} = T B L {D}_{k , j + 1} * H + d e l t a B A {L}_{k , j + 1} * G & [ 27 ] \\ ( 1 {0}^{c} * C M {T}_{j + 2} ) = ( 1 {0}^{c} * T B L {D}_{k , j + 1} ) * H + ( 1 {0}^{c} * d e l t a B A {L}_{k , j + 1} ) * G & [ 28 ] \\ Let T B L {D}_{k , j + 1} = {d}_{3} * \frac{T B L {D}_{i , j}}{1 {0}^{c}} & [ 29 ]\end{matrix}$$

Note that there should be a validation before initial transaction happens that TBLD_{i,j} should have c zeros in the end similar to validating amount transferred.

Using Equations [25], [26], [28], and [29]; Equation [30] is true.

d₃*CMTⱼ₊₁=10^{c}*CMTⱼ₊₂ [30]

Validating that that the Merchant claims a certain portion of initial transfer from Equation [24] is equivalent to validating the commitment points of Equation [30]. Equation [30] does not require the knowledge of the transacted amount which ensures the confidentiality of the transaction and at the same time any network participant can validate that the Merchant claimed the correct portion of the initial transfer without knowing the value of the transfer.

The next step is to validate that the Merchant correctly debits the claimed portion to his balance. See Equations [31], [32], [33], and [34].

BALₖ₊₁=BALₖ+deltaBAL_{k,j+1} [31]

CMTₖ=BLDₖ*H+BALₖ*G [32]

CMTₖ₊₁=BLDₖ₊₁*H+BALₖ₊₁*G=(BLDₖ+TBLD_{k,j+1})*H+(BALₖ+deltaBAL_{k,j+1})*G=BLDₖ*H+BALₖ*G+TBLD_{k,j+1}*H+deltaBAL_{k,j+1}*G=CMTₖ+TBLD_{k,j+1}*H+deltaBAL_{k,j+1}*G=CMTₖ+CMTⱼ₊₂ [33]

CMTₖ₊₁=CMTₖ+CMTⱼ₊₂ [34]

Validating that the new Merchant balance after the transaction equals to the sum of the old balance and the claimed portion of the transacted amount, as shown in Equation [31], is equivalent to validating that the commitment Elliptic Curve point representing the new Merchant balance after the transaction equals to the sum of commitment points representing the old balance and the claimed portion of the transacted amount, as shown in Equation [34], provided that H is selected so that no one knows the discrete logarithm for H with respect to G and that the balance and the claimed portion is not a negative number and does not overflow when two numbers are added.

After the Merchant claims his portion of initial transfer, the Customer can claim the rest of the funds. See Equation [35].

deltaBAL_{i+1,j+2}=deltaBAL_{i,j}−deltaBAL_{k,j+1} [35]

Using Equations [21] and [35], then Equation [36] is true. Next see Equations [37], [38], and [39].

deltaBAL_{i+1,j+2}=deltaBAL_{i,j}−d₂*deltaBAL_{i,j} [36]

Let d₄=1−d₂ [37]

deltaBAL_{i+1,j+2}=d₄*deltaBAL_{i,j} [38]

Let d₅=d₄*10^{c} [39]

In Equation [39], d₅ is now a non-negative integer, next see Equation [40].

$$d e l t a B A {L}_{i + 1 , j + 2} = {d}_{5} * \frac{deltaB {AL}_{i , j}}{1 {0}^{c}} \qquad [ 40 ]$$

Equation [40] is similar to Equation [24] and the proof with the result is similar to Equations [41] and [42].

$$\begin{matrix}Let T B L {D}_{i + 1 , j + 2} = {d}_{5} * \frac{T B L {D}_{i , j}}{1 {0}^{c}} & [ 41 ] \\ {d}_{5} * C M {T}_{j + 1} = 1 {0}^{c} * C M {T}_{j + 3} & [ 42 ]\end{matrix}$$

Validating that that the Customer claims the rest portion of initial transfer (40) is equivalent to validating the commitment points Equation [42]. Equation [42] does not require the knowledge of the transacted amount which ensures the confidentiality of the transaction and at the same time any network participant can validate that the Customer claimed the correct portion of the initial transfer without knowing the value of the transfer.

The last step is to validate that the Customer correctly debits the claimed portion to his balance as shown in Equation [43].

BALᵢ₊₂=BALᵢ₊₁+deltaBAL_{i+1,j+2} [43]

Equation [43] is similar to Equation [31] and the proof with the result is similar to Equation [44].

CMTᵢ₊₂=+CMTᵢ₊₁+CMTⱼ₊₃ [44]

Validating that the Customer's new balance after the transaction equals to the sum of the old balance and the claimed portion of the transacted amount, as shown in Equation [43], is equivalent to validating that the commitment Elliptic Curve point representing the Customer's new balance after the transaction equals to the sum of commitment points representing the old balance and the claimed portion of the transacted amount, as shown in Equation [44], provided that H is selected so that no one knows the discrete logarithm for H with respect to G and that the balance and the claimed portion is not a negative number and does not overflow when two numbers are added.

It can be proved as shown in Equation [47] and (50) that the transaction done with the method does not create new money. To start, see Equation [45].

BALᵢ+BALₖ=BALᵢ₊₂+BALₖ₊₁ [45]

Equation [45] can be also validated with commitments without knowing the balances as shown in Equation [46].

CMTᵢ+CMTₖ=CMTᵢ₊₂+CMTₖ₊₁ [46]

Using Equations [5], [6], [31], [43], [36], and [21]; Equation [47] can be formulated.

BALᵢ₊₂+BALₖ₊₁=BALᵢ₊₁+deltaBAL_{i+1,j+2}+BALₖ+deltaBAL_{k,j+1}=BALᵢ₊₁+deltaBAL_{i,j}−d₂*deltaBAL_{i,j}+BALₖ+d₂*deltaBAL_{i,j}=BALᵢ+BALₖ [47]

Using Equations [46], [44], [34], [10], [30], [42], [23], [37], and [39]; Equations [48], [48] and [50] can be formulated.

10^{c}*CMTⱼ₊₂+10^{c}*CMTⱼ₊₃=d₃ CMTⱼ₊₁+d₅*CMTⱼ₊₁=d₃*CMTⱼ₊₁+(1−d₂)*10^{c}*CMTⱼ₊₁=d₂*10^{c}*CMTⱼ₊₁+10^{c}*CMTⱼ₊₁−d₂*10^{c}*CMTⱼ₊₁=10^{c}*CMTⱼ₊₁ [48]

CMTⱼ₊₂+CMTⱼ₊₃=CMTⱼ₊ᵢ [49]

CMTᵢ₊₂+CMTₖ₊₁=+CMTᵢ₊₁+CMTⱼ₊₃+CMTₖ+CMTⱼ₊₂=CMTᵢ−CMTⱼ₊₁+CMTⱼ₊₃+CMTₖ+CMTⱼ₊₂=CMTᵢ+CMTₖ [50]

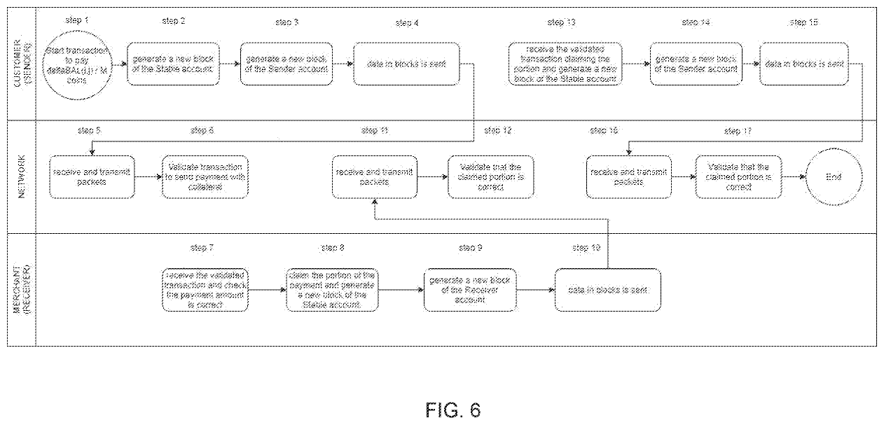

FIG. 6 shows an activity flow diagram describing each step of the method and system.

In Step 1, the Sender with head block BlockAᵢ initiates stable transaction to pay

$$\frac{deltaB {AL}_{i , j}}{M}$$

coins (or other digital assets) to the Merchant (Receiver) with collateral ratio M by sending deltaBAL_{i,j} coins (or other digital assets) to the Stable account with head block BlockSBⱼ belonging to the Receiver with head block BlockBₖ.

In Step 2, the Sender generates the next block of the Stable account. deltaBAL_{i,j} is encrypted using Shared Key_{i,j} in Equation [2] and stored in the block of the Stable account. The sender validates that deltaBAL_{i,j} has precision c with c zeros in the end. Transaction blinding is generated as a large random number TBLD_{i,j} with precision c (c zeros in the end) and encrypted using Shared Key_{i,j} in Equation [2] and stored in the block. Stable account's next block commitment is calculated with Equation [8]. Stable account's zero-knowledge proof ZKⱼ₊₁ is calculated using zero-knowledge proof protocol, for example Bulletproof (deltaBAL_{i,j},TBLD_{i,j}, CMTⱼ₊₁).

In Step 3, the Sender generates the next block of his own account. The Sender's new balance is calculated using Equation [5] and encrypted with sender's private key. The Sender's next block blinding is calculated with Equation [3] and encrypted with sender's private key. The Sender's commitment is calculated with Equation [7] or [9]. The Sender's zero-knowledge proof ZKᵢ₊₁ is calculated using zero-knowledge proof protocol, for example Bulletproof (BALᵢ₊₁, BLDᵢ₊₁, CMTᵢ₊₁).

In Step 4, data is sent to the network: deltaBAL_{i,j}, TBLD_{i,j}, CMTᵢ₊₁, CMTᵢ, ZKᵢ₊₁, ZKᵢ, CMTⱼ₊₁, ZKⱼ₊₁. Additional data may be sent as well, like sender/stable account public key address, block hashes, signatures, BLDᵢ₊₁, BLDᵢ, BALᵢ₊₁, BALᵢ, etc. Also previous block data could be sent before, and is included to better explain the concept.

In Step 5, the network is receiving and transmitting packets.

In Step 6, all network participants can validate the transaction using Equation [10] and verifying ZKᵢ₊₁ and ZKⱼ₊₁ using zero-knowledge proof protocol, for example Bulletproof (ZKᵢ₊₁, CMTᵢ₊₁), Bulletproof (ZKⱼ₊₁, CMTⱼ₊₁)

In Step 7, the Merchant can validate the payment with collateral deltaBAL_{i,j} as he knows the Shared Key_{i,j} in Equation [2].

In Step 8, at some point of time during Stable period T the Merchant claims his portion deltaBAL_{k,j+1} of the transacted amount. The next block of the Stable account is generated. deltaBAL_{k,j+1} is calculated using Equation [24]. TBLD_{k,j+1} is calculated using Equation [29]. CMTⱼ₊₂ is calculated using Equation [8]. ZKⱼ₊₂ is calculated using zero-knowledge proof protocol, for example Bulletproof (deltaBAL_{k,j+1}, TBLD_{k,j+1}, CMTⱼ₊₂).

In Step 9, the Merchant (Receiver) is generating the next block of his account BlockBₖ₊₁. The new balance BALₖ₊₁ is calculated using Equation [31]. BLDₖ₊₁ is calculated using Equation [4]. CMTₖ₊₁ is calculated using Equation [7]. ZKₖ₊₁ is calculated using zero-knowledge proof protocol, for example Bulletproof (BALₖ₊₁, BLDₖ₊₁, CMTₖ₊₁).

In Step 10, data is sent to the network: deltaBAL_{k,j+1}, TBLD_{k,j+1}, CMTₖ₊₁, CMTₖ, ZKₖ₊₁, ZKₖ, CMTⱼ₊₂, ZKⱼ₊₂. Additional data may be sent as well, like receiver/stable account public key address, block hashes, signatures, BLDₖ₊₁, BLDₖ, BALₖ₊₁, BALₖ, etc. Also previous block data could be sent before, and is included to better explain the concept.

In Step 11, the network is receiving and transmitting packets.

In Step 12, all network participants can validate the transaction using Equation [34] and verifying ZKⱼ₊₂ and ZKₖ₊₁ using zero-knowledge proof protocol, for example Bulletproof (ZKⱼ₊₂, CMTⱼ₊₂), Bulletproof (ZKₖ₊₁, CMTₖ₊₁) Also the network participants should validate that the Merchant has not previously claimed the funds from that payment and that he is the original creator of the Stable account by checking the Originating Account field. Also they should verify the exchange rate difference using the ledger of the exchange rate.

In Step 13, the Customer (Sender) claims the rest portion deltaBAL_{i+1,j+2} of the payment with collateral. The next block of the Stable account is generated. deltaBAL_{i+1,j+2} is calculated using Equation [40]. TBLD_{i+1,j+2} is calculated using Equation [41]. CMTⱼ₊₃ is calculated using Equation [8]. ZKⱼ₊₃ is calculated using zero-knowledge proof protocol, for example Bulletproof (deltaBAL_{i+1,j+2}, TBLD_{i+1,j+2}, CMTⱼ₊₃).

In Step 14, the Customer (Sender) is generating the next block of his account BlockAᵢ₊₂. The new balance BALᵢ₊₂ is calculated using equation [43]. BLDᵢ₊₂ is calculated using Equation [4]. CMTᵢ₊₂ is calculated using Equation [7]. ZKᵢ₊₂ is calculated using zero-knowledge proof protocol, for example Bulletproof (BALᵢ₊₂, BLDᵢ₊₂, CMTᵢ₊₂).

In Step 15, data is sent to the network: deltaBAL_{i+1,j+2}, TBLD_{i+1,j+2}, CMTᵢ₊₂, ZKᵢ₊₂, ZKᵢ₊ᵢ,CMTⱼ₊₃, ZKⱼ₊₃. Additional data may be sent as well, like sender/stable account public key address, block hashes, signatures, BLDᵢ₊₂, BLDᵢ₊₁, BALᵢ₊₂, BALᵢ₊₁, etc. Also previous block data could be sent before and is included to better explain the concept.

In Step 16, the network is receiving and transmitting packets.

In Step 17, all network participants can validate the transaction using Equation [44] and verifying ZKⱼ₊₃ and ZKᵢ₊₂ using zero-knowledge proof protocol, for example Bulletproof (ZKⱼ₊₃, CMTⱼ₊₃), Bulletproof (ZKᵢ₊₂, CMTᵢ₊₂). They should check that the Sender did not claim the rest portion of the initial payment before.

FIG. 7 illustrates a method and data structure to support offline transactions in a Confidential Multi-Chain. Normally the network node running an account is online and when peer-to-peer network passes sender transaction, then the receiver gets the sender's block and will generate the receiver's block to complete transaction. If the receiver node is offline then the transaction does not go through and may eventually timeout. To support offline transactions, a special Offline Account type is introduced. Offline Account is similar to Stable Account with the difference that the receiver must claim the whole transferred amount (while in Stable account, the receiver claims a portion and then the sender claims the rest portion of the initial transfer). The receiver creates and registers an Offline Account to get offline transfers. The Offline Account has Originating Account field which identifies the owner so that only the owner can withdraw funds from it. It has Debit Timestamp field to refer to the block from which the funds are claimed. It exposes Account Private Key so that the sender can put funds into it. The sender creates a block for the Offline Account with deltaBAL_{i,j},TBLD_{i,j}, commitment, zero-knowledge proof and other fields and signs the block with the exposed private key. The sender also creates a block for this own account with the fields for a regular account and signs the block with his own private key (kept in secret). The receiver claims funds from the Offline Account by creating a block (in his offline account) which refers to the original block by Debit Timestamp field and also by creating a block in own regular receiver account. The method to conceal the balances and amounts transferred and to validate the transactions without knowing the balances and amounts transferred is similar to method for the Stable account with the difference that the receiver claims the whole transacted amount. All transactions are validated by a set of Master Nodes that participate in voting and operate by certain rules and have incentive/penalty to obey the rules. So, if the account is not eligible to claim the funds then Master Nodes will not vote for the transaction. If the sender is trying to claim more coins than were sent, then Master Nodes will not vote for the transaction and the transaction will get denied.

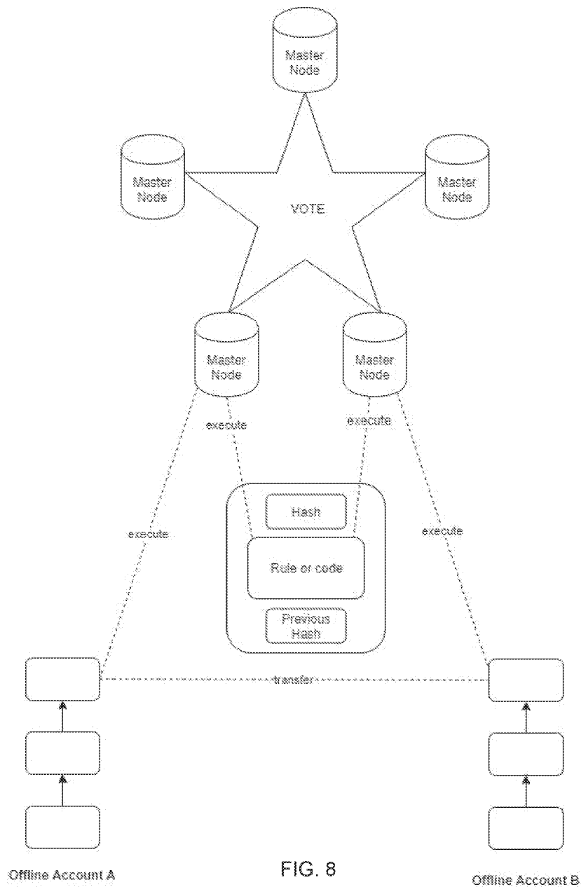

FIG. 8 illustrates the smart contract method to execute transactions in a Confidential Multi-Chain. The method is comprised of a ledger with blocks containing a condition and/or a rule and/or code to execute, account chains, a set of special incentivized network nodes (Master Nodes). Sender and/or receiver construct a block with a condition and/or a rule and/or a code (smart contract) and both sign it. The special incentivized nodes (Master Nodes) check the conditions of the contract and execute transfers either from the offline account to online account or between offline accounts, based these rules and/or code. The transfers are executed with the methods and data structures, and same balance and transacted amounts concealing methods described above. The transfers are validated by all the Master Nodes and are approved or denied based upon the majority of votes.

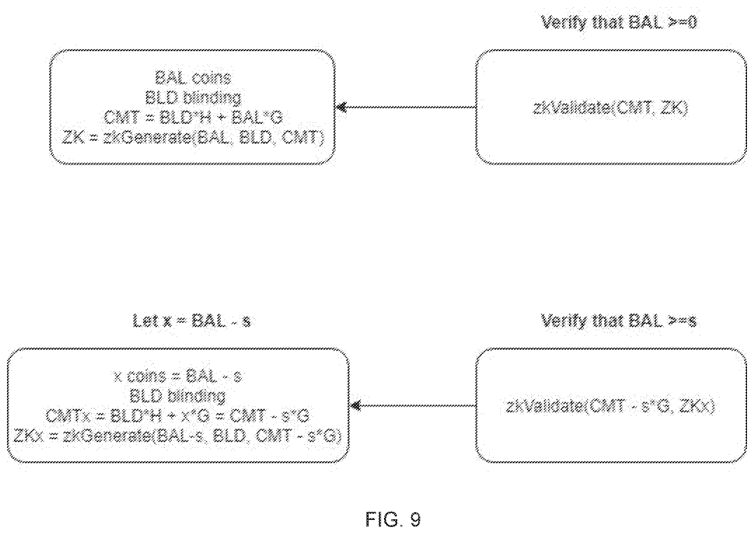

FIG. 9 illustrates the method to validate that the account has at least s amount of coins without knowing the exact amount. As described above, some of the functions rely upon voting of the Master Nodes, where a Master Nodes is a special incentivized network node holding a significant amount of coins. There is a problem of validating by all network participants that the Master Nodes has at least s amount of coins, where this minimum threshold s is predefined by the system. Let BAL and BLD be the balance and block blinding of the Master Node head block. Then commitment of the block is calculated by Equation [51].

CMT=BLD*H+BAL*G [51]

Zero-knowledge proof ZK is calculated as shown in Equation [52].

ZK=zkGenerate(BAL,BLD,CMT) [52]

One example of such function is Bulletproof generation function.

As described above, all network participants can validate that BAL is a non-negative number with the function: zkValidate(CMT, ZK).

One example of such function is Bulletproof validation function.

Equations [53], [54]. [55], and [56] show a validation that BAL is at least s, meaning that account has at least s coins.

Let x=BAL−s [53]

CMTₓ=BLD*H+x*G=BLD*H+BAL*G−s*G=CMT−s*G [54]

ZKₓ=zkGenerate(x,BLD,CMTₓ) [55]

ZKₓ=zkGenerate(BAL−s,BLD,CMT−s*G) [56]

To validate that x is a non-negative number, Equation [57] can be used.

zkValidate(CMTₓ,ZKₓ)=zkValidate(CMT−s G,ZKₓ) [57]

If x is non-negative number that means that BAL is at least s or account has at least s coins.

To summarize, to validate that the account has at least s coins, the account owner should generate zero-knowledge proof as shown in Equation [58].

ZKₓ=zkGenerate(BAL−s,BLD,CMT−s*G) [58]

And all network participants can validate with Equation [59].

zkValidate(CMT−s*G,ZKₓ) [59]

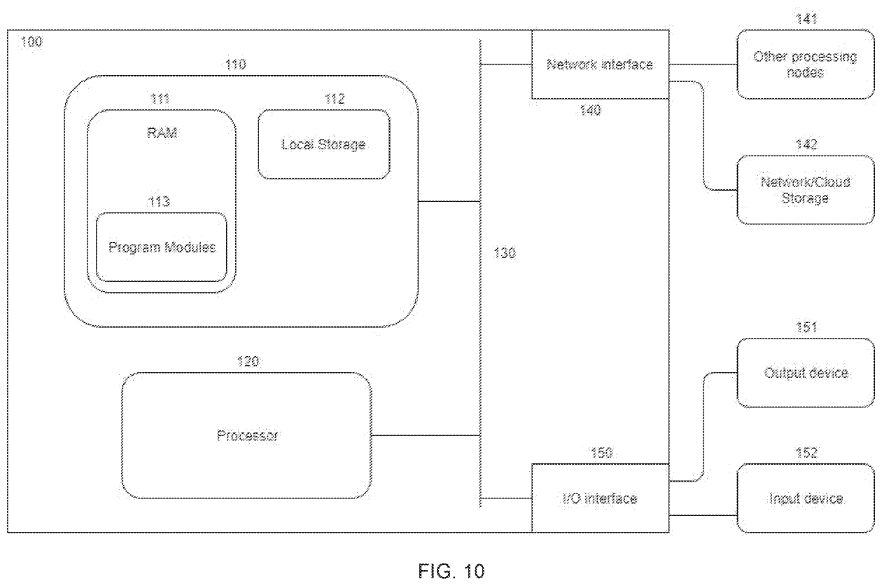

FIG. 10 illustrates one example of a system to implement the subject matter disclosed herein, including concealing the balance and transacted amounts, processing, and validating a payment transaction with or without stabilization. It includes computing hardware device 100, which has a processor 120, memory 110, network interface 140, I/O interface 150 and a bus 130 which connects these parts.

The memory 110 may include random access memory (RAM) 111 or any other type of volatile memory, local disk storage 112 including hard disk drive, SSD or any other type of non-volatile memory. Program modules 113 are loaded into RAM which may include Operating System, program data and program executable instructions.

The processor 120 together with the memory 110 implements the data structures and methods described in FIG. 1 through FIG. 9. The described above executable instructions and data are loaded from the local storage 112 into RAM memory 111 and processed by the processor 120. The computer system has I/O interface 150 to read user input from Input device 152 including, but not limited to, keyboard or mouse pointing device, and to display the result on Output device 151 including, but not limited to, monitor or printer.

Network interface 140 is used by the system to communicate with other processing nodes 141 that can participate in transactions or observe and validate them or with network storage devices 142.

The bus 130 links memory 110, processor 120, network interface 140 and I/O interface 150. The bus 130 represents one or more bus structures, including but not limited to, memory bus, local bus, peripheral bus, etc.

It should be understood that the methods defined in the claims and above can be implemented entirely as a hardware component, for example as a specialized circuits, entirely as a software component or a combination of both. It is to be understood that FIG. 10 illustrates one possible implementation and other variations are possible which may include any combination of any hardware components, thus the example should not be considered as limiting.

In conclusion, herein is disclosed systems, devices, and methods that provide a stable on-chain transaction between two parties where one party holds a potentially volatile digital asset and the second party receives the transacted amount that is pegged to fiat currency, where the transacted amount and balances are cryptographically concealed with the ability for the network to verify a transaction between any two accounts.

There is no existing solution for volatility problem of the merchants accepting cryptocurrencies that will have privacy and/or be scalable and/or be on-chain and while staying publicly verifiable. It is important for wide adoption of a cryptocurrency or payment system that network participants cannot see each other's balance and transacted amount especially balance of merchant accounts. Introduced herein is a Confidential Multi-chain structure used to implement the methods. Disclosed are the systems, devices, and methods to generate the stable private transaction, pass it through the network, claim the digital assets, and validate by any network participant. Also, disclosed are the systems, devices, and methods to determine and store a digital asset price in a ledger, the method to claim a payment from another account so that the second account cannot refuse to pay, the method to execute offline transactions, the method to execute transactions using smart contract in a Confidential Multi-Chain, and the method to validate that the account has at least s amount of coins without knowing the exact amount. Also the same methods can work without privacy layer when the balance and transacted amounts are not encrypted in the ledger. Also, described are the methods defined in the claims that can be implemented entirely as a hardware component, for example as a specialized circuit(s), entirely as a software component or a combination of both.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1) A computer-based method of stabilizing the value, transferred using a volatile digital asset, relative to fiat currency, with or without privacy, comprising:
sending transacted amount with collateral, by the processor, by sender, using a volatile digital asset to the intermediate account belonging to the receiver;
calculating, by the processor, the exchange rate difference between time when transaction initially happened and time of the claim;
claiming the portion of the transacted amount with collateral, by the processor, by receiver, so that the value in fiat currency for the receiver stays the same; and
claiming the rest portion of the initial transfer with collateral, by the processor, by sender.

2) A computer-based method of concealing an account balance and transacted amounts, and collateral with the ability for the network to verify a transaction between any two accounts in a case when transacted value is stabilized using intermediate account, comprising:
encrypting transacted amount with collateral, by a processor, by sender, using shared (between sender and receiver) key, and storing it in intermediate account block;
generating transaction blinding, by the processor, by sender, and encrypting it using shared (between sender and receiver) key, and storing it in intermediate account block;
decreasing sender's account balance by transacted amount with collateral, by the processor, by sender, encrypting sender's new account balance with sender's private key;
calculating sender's next block blinding, by the processor, by sender, and encrypting it with sender's private key;
calculating, by the processor, new sender's commitment which is sender's new balance representation on the elliptic curve, calculating intermediate account block's new commitment which is transacted amount (with collateral) representation on the elliptic curve;
calculating, by the processor, by sender, zero knowledge proofs that sender's new balance and intermediate account block's transferred amount are more or equal than zero, and are not too large in a way that their sum may cause numerical overflow;
calculating, by the processor, by receiver, the correct portion of the initial transfer during claiming phase based upon exchange rate movement and encrypting it using shared (between sender and receiver) key, and storing it in intermediate account block;
calculating, by the processor, by receiver, the new transaction blinding of the intermediate account block, encrypting it using shared key;
calculating, by the processor, by receiver, new commitment and zero-knowledge proof of the intermediate account block;
calculating, by the processor, by receiver, new receiver's account balance and encrypting it with the private key, new block blinding and encrypting it with the private key, new commitment and zero-knowledge proof;
calculating, by the processor, by sender, the rest of the portion of the initial transfer during claiming phase based upon exchange rate movement and encrypting it using shared (between sender and receiver) key, and storing it in intermediate account block;
calculating, by the processor, by sender, the new transaction blinding of the intermediate account block, encrypting it using shared key;
calculating, by the processor, by sender, new commitment and zero-knowledge proof of the intermediate account block; and
calculating, by the processor, by sender, new sender's account balance and encrypting it with the private key, new block blinding and encrypting it with the private key, new commitment and zero-knowledge proof.

3) A computer-based system and method of validating by all network participants a payment transaction between accounts through the intermediate account whose balances were concealed using the method from claim 2 in a case when transacted value is stabilized using intermediate account, comprising:
getting sender's and intermediate account's initial transfer (with collateral) data from the network including commitments, zero knowledge proofs, encrypted balances, encrypted blinding values, encrypted transacted amount with collateral;
verifying zero knowledge proofs that sender's new balance and intermediate account's initial transfer value are more or equal than zero, and are not too large in a way that their sum may cause numerical overflow;
verifying the sender's and intermediate account's commitment points on the elliptic curve to make sure no new assets were created in the system;
getting exchange rate movement data during time of the initial transfer and time of claiming the funds by the receiver;
getting transaction data of the receiver to claim the portion of the initial transfer from the network including commitments, zero knowledge proofs, encrypted balances, encrypted blinding values, encrypted portion of the initial transfer;
verifying zero knowledge proofs that receiver's new balance and intermediate account's portion of the initial transfer are more or equal than zero, and are not too large in a way that their sum may cause numerical overflow;
verifying the receiver's and intermediate account's commitment points on the elliptic curve to make sure no new assets were created in the system;
verifying the correct portion of the initial transfer was claimed by receiver using the intermediate account's commitment points and exchange rate movement;
getting transaction data of the sender to claim the rest portion of the initial transfer from the network including commitments, zero knowledge proofs, encrypted balances, encrypted blinding values, encrypted rest portion of the initial transfer;
verifying zero knowledge proofs that sender's new balance and intermediate account's rest portion of the initial transfer are more or equal than zero, and are not too large in a way that their sum may cause numerical overflow;
verifying the sender's and intermediate account's commitment points on the elliptic curve to make sure no new assets were created in the system; and
verifying the correct portion of the initial transfer was claimed by sender using the intermediate account's commitment points and exchange rate movement.
